(19) United States
(12) Patent Application Publication
(10) Pub. No.: US 2014/0229337 A1
(43) Pub. Date: Aug. 14, 2014

(54) ORDER MANAGEMENT SYSTEM AND ORDER MANAGEMENT METHOD THEREOF

(71) Applicant: INTERFACE OPTOELECTRONICS CORPORATION, (US)

(72) Inventor: Chien-Erh WANG, Shenzhen (TW)

(73) Assignee: INTERFACE OPTOELECTRONICS CORPORATION, Shenzhen (CN)

(21) Appl. No.: 13/831,861

(22) Filed: Mar. 15, 2013

(30) Foreign Application Priority Data
Feb. 8, 2013 (CN) 201310050279.X

(51) Int. Cl. G06Q 30/00

(52) U.S. Cl. CPC G06Q 30/00
USPC 705/26.81

(57) ABSTRACT

A computer implemented order management system includes a data media module, a mail receiving module, a file creating module, a calculating module, an order confirmation module, an order receiving module, and a shipment module. The data media module is for providing a product requirement application form to be downloaded by a customer. The mail receiver module is for receiving the product requirement application form filled out by the customer. The file creating module is for creating a requirement file. The calculating module is for estimating and providing a delivery date, a quantity, and a quotation. The order confirmation module is for confirming whether the customer accepts the delivery date, the quantity, and the quotation. The order receiving module is for receiving and confirming an order form provided by the customer. The shipment module is for arranging shipment to the customer according to the order form.

### RELATED APPLICATIONS

This application claims priority to China Application Serial Number 201310050279.X, filed Feb. 8, 2013, which is herein incorporated by reference.

### BACKGROUND

1. Field of Invention

The invention relates to an order management system.

2. Description of Related Art

With the development of science and technology industry, personal desires for receiving information in time become higher and higher, and thus the market of a personal sci-tech product, such as a smart phone, a tablet computer, and a notebook computer is increased greatly. Especially for a display device with a touch-type panel, since a user can input a signal by touching a touch panel through a finger or induction pen, which can facilitate the information processing speed of the user, the display device with a touch-type panel has become the main trend in current sci-tech products.

The touch-type panel mainly includes a display panel, a touch panel, and a backlight module. With respect to a conventional touch display panel, the display panel, touch panel, and backlight module thereof are typically first manufactured independently in different factory rooms, and then delivered one by one to the same factory room to assembly and form the touch-type panel. As such, from receiving an order from the customer to completing of production shipping, the procedures at different stages of quality control of the touch-type panel and other procedures will become very complicated, which may also increase error probability of the product.

### SUMMARY

Therefore, an aspect of the invention provides an order management method applied for a touch and display device. The order management method includes the following steps (It should be understood that for the steps stated herein, the performing sequence thereof can be adjusted according to actual demands, or alternatively the steps can be all or partially performed at the same time, unless the performing sequence is stated specifically):

providing a product requirement application to be downloaded by at least one customer;

receiving the product requirement application filled by the customer;

creating a requirement file according to the product requirement application;

predicting a due date, a quantity, and a quotation of the touch and display device for the customer according to the requirement file and then replying to the customer;

checking if the customer accepts the due date, the quantity, and the quotation of the touch and display device;

receiving a preparation order from the customer and checking the preparation order if the customer accepts; and

arranging production shipping to the customer according to the preparation order.

In one or more embodiments, the order management method optionally further includes:

determining whether a new requirement of the requirement file is a volume-production product; and

checking the cost and production shipping plan of the volume-production product if the new requirement is the volume-production product; and

wherein the aforesaid step of replying the due date, the quantity, and the to quotation of the touch and display device to the customer includes: replying the due date, the quantity, and the quotation of the touch and display device to the customer according to the cost and production shipping plan of the volume-production product.

In one or more embodiments, the order management method optionally further includes:

determining whether a new requirement of the requirement file is a volume-production product; and

preparing a sample and providing the due date and cost information thereof to the customer if the new requirement is not a volume-production product; and

wherein the aforesaid step of replying the due date, the quantity, and the quotation of the touch and display device to the customer includes: replying the due date, the quantity, and the quotation of the touch and display device to the customer according to the sample and the due date and cost information thereof.

In one or more embodiments, order management method optionally further includes:

checking whether the customer is a new customer; and

performing a new-customer application and a credit-line examination procedure to the customer if the customer is the new customer.

In one or more embodiments, the aforesaid step of arranging production shipping to the customer optionally includes:

checking the inventory or production plan of the touch and display device;

arranging product checking and packaging operations to the touch and display device; and

arranging a shipping operation to the packaged touch and display device.

Another aspect of the invention provides an order management system applied for a touch and display device. The order management system includes a data media module, a mail receiver module, a file creating module, a budget module, an order check module, an order receiver module, and a delivery module. The data media module is used for providing a product requirement application to be downloaded by at least one customer. The mail receiver module is used for receiving the product requirement application filled by the customer. The file creating module is used for creating a requirement file according to the product requirement application. The budget module is used for predicting a due date, a quantity, and a quotation of the touch and display device for the customer and then replying to the customer. The order check module is used for checking if the customer accepts the due date, the quantity, and the quotation of the touch and display device. The order receiver module is used for receiving a preparation order from the customer and checking the preparation order if the customer accepts. The delivery module is used for arranging production shipping to the customer according to the preparation order.

In one or more embodiments, the order management system further includes a volume-production examination module and a production shipping plan module. The volume-production examination module is used for determining whether a new requirement of the requirement file is a volume-production product. The production shipping plan module is used for checking the cost and production shipping plan of the volume-production product if the new requirement is the volume-production product. The budget module replies a due date, a quantity, and a quotation of the touch and display device to the customer according to the cost and production shipping plan of the volume-production product.

In one or more embodiments, the order management system optionally further includes a volume-production examination module and a sample providing module. The volume-production examination module is used for determining whether a new requirement of the requirement file is a volume-production product. The sample providing module is used for preparing a sample and providing the due date and cost information thereof to the customer if the new requirement is not a volume-production product. The budget module replies the due date, the quantity, and the quotation of the touch and display device to the customer according to the sample and the due date and cost information thereof.

In one or more embodiments, the order management system optionally further includes a customer examination module and a new-customer examination module. The customer examination module is used for checking whether the customer is a new customer. The new-customer examination module is used for performing a new-customer application and a credit-line examination procedure to the customer if the customer is the new customer.

In one or more embodiments, the delivery module optionally includes a check unit, a packaging unit, and a storage and delivery unit. The check unit is used for checking the inventory or production plan of the touch and display device. The packaging unit is used for arranging product checking and packaging operations to the touch and display device. The storage and delivery unit is used for arranging a shipping operation to the packaged touch and display device.

### BRIEF DESCRIPTION OF THE DRAWINGS

FIG. 1 is a function block diagram of an order management system according to an embodiment of the present invention;

FIG. 2 is a function block diagram of a budget module shown in FIG. 1;

FIG. 3 is a function block diagram of an order receiver module shown in FIG. 1;

FIG. 4 is a function block diagram of a delivery module shown in FIG. 1;

FIG. 5 is a function block diagram of a check unit shown in FIG. 4;

FIG. 6 is a function block diagram of a packaging unit shown in FIG. 4;

FIG. 7 is a function block diagram of a storage and delivery unit shown in FIG. 4;

FIG. 8 is a function block diagram of the order management system according to another embodiment of the present invention;

FIG. 9 is a function block diagram of a customer examination module shown in FIG. 8;

FIG. 10 is a customer dynamic management table according to an embodiment of the present invention;

FIG. 11 is a function block diagram of a new-customer examination module shown in FIG. 8;

FIG. 12 is a function block diagram of a production shipping plan module shown in FIG. 8;

FIG. 13 is a flow chart of an order management method according to an embodiment of the present invention;

FIG. 14 is a detailed flow chart of steps 601-620 shown in FIG. 13;

FIG. 15 is a detailed flow chart of steps 620-641 shown in FIG. 13; and

FIG. 16 is a detailed flow chart of step 650 shown in FIG. 13.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

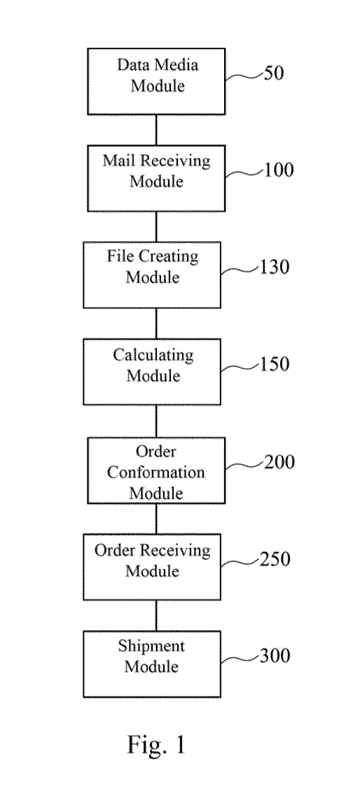

FIG. 1 is a function block diagram of an order management system according to an embodiment of the present invention. The order management system can be applied in a touch and display device, and the order management system includes a data media module 50, a mail receiver module 100, a file creating module 130, a budget module 150, an order check module 200, an order receiver module 250, and a delivery module 300. The data media module 50 is used for providing a product requirement application to be downloaded by at least one customer. The mail receiver module 100 is used for receiving the product requirement application filled by the customer. The file creating module 130 is used for creating a requirement file according to the product requirement application. The budget module 150 is used for predicting a due date, a quantity, and a quotation of the touch and display device for the customer and then replying to the customer. The order check module 200 is used for checking if the customer accepts the due date, the quantity, and the quotation of the touch and display device. The order receiver module 250 is used for receiving a preparation order from the customer and checking the preparation order if the customer accepts. The delivery module 300 is used for arranging production shipping to the customer according to the preparation order. As such, the order management system of this embodiment integrates order, budget, delivery and the like procedures as a whole to manage, which is more integrated than a general management procedure, on one hand being convenient for managing all the procedures unitedly, and on the other hand reducing error probability.

Then the data media module 50, the mail receiver module 100, and the file creating module 130 are described in details. The order management system for example can place a product requirement application in the data media module 50, so that a customer with a new requirement can grab the product requirement application from the data media module 50 and fill the same. Thereafter the mail receiver module 100 can also grab the filled product requirement application from the data media module 50, and transmit the same to the file creating module 130, so as to establish a requirement file for the new requirement of the customer.

Particularly, the customer can first predict the requirement for the touch and display device to be produced, for example performing a forecast (FCST) to the production requirement of the touch and display device in the following 3-6 months. After the predicted production requirement of the product to be produced is checked, the customer end can download the product requirement application from the data media module 50 to fill, so as to provide details of the predicted product to be produced by the order management system. The product requirement application is typically has a form of email or excel file. After the application is filled, the customer can feed the product requirement application back to the data media module 50, and the mail receiver module 100 can grab the product requirement application filled by the customer from the data media module 50 and transmit the same to the file creating module 130 to establish a requirement file for the new requirement. In one or more embodiments, the aforesaid data media module 50 can be arranged in a cloud system, but the invention is not limited to this. Those of ordinary skills in the art of the invention can flexibly select the type of the data media module 50 according to actual demands.

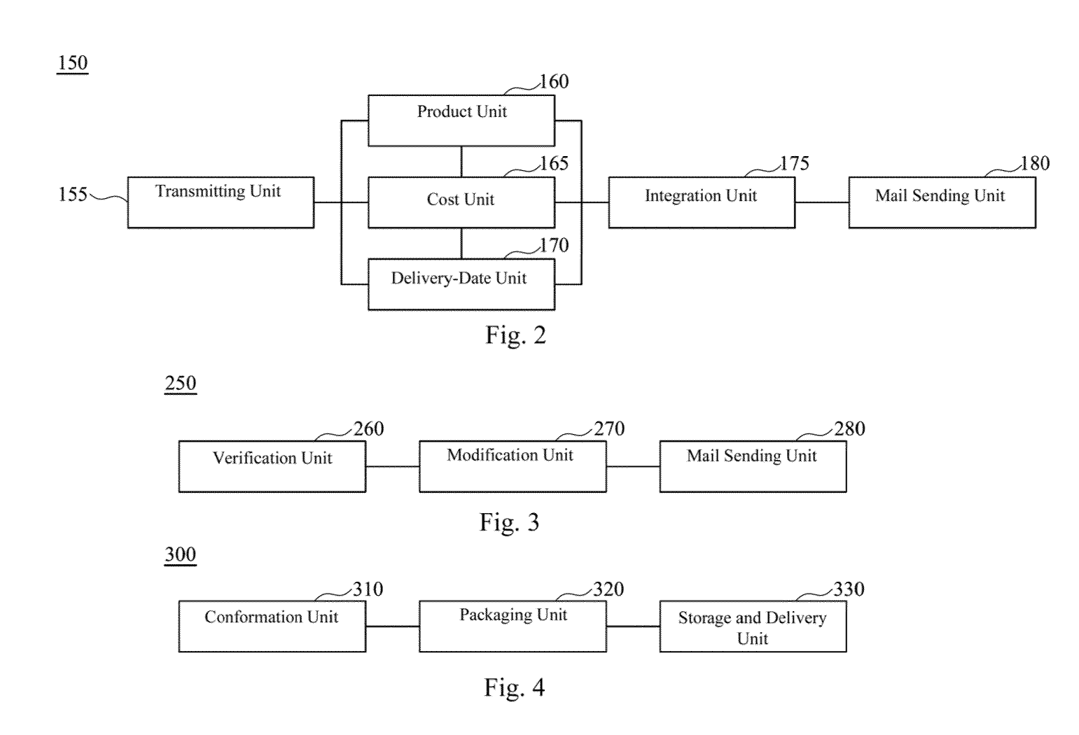

Subsequently reference is made to FIG. 2. FIG. 2 is a function block diagram of the budget module 150 shown in FIG. 1. The budget module 150 includes a transmitting unit 155, a product unit 160, a cost unit 165, a due-date unit 170, an integration unit 175, and a mail transmitter unit 180. The transmitting unit 155 is used for transmitting the requirement file established by the file creating module 130 of FIG. 1 individually to the product unit 160, the cost unit 165, and the due-date unit 170. The product unit 160 is used for predicting the output details of the product according to the requirement file. The cost unit 165 is used for calculating the production cost of the product according to the requirement file. The due-date unit 170 is used for determining the due date of the product according to the output details of the product predicted by the product unit 160. The integration unit 175 integrates the output details of the product, the production cost of the product, and the due date of the product as a budget file, and the mail transmitter unit 180 is used for transmitting the budget file to the customer to check.

Particularly, after the file creating module 130 of FIG. 1 completes establishment of the requirement file, the transmitting unit 155 transmits the requirement file individually to the product unit 160, cost unit 165, and due-date unit 170 of the budget module 150, to generate the output details of the product, the production cost of the product, and the due date of the product and transmit the same to the integration unit 175 to integrate as the budget file, and then the budget file is transmitted to the mail transmitter unit 180. The mail transmitter unit 180 then transmits the budget file to the customer, and the customer checks and determines whether to accept the budget file. In one or more embodiments, the mail transmitter unit 180 may be arranged in the cloud system, such that the integration unit 175 can upload the budget file to the cloud system, and the customer can also grab the budget file from the cloud system, but the invention is not limited to this.

Hereafter the order check module 200 is described in details. Reference is made back to FIG. 1. Subsequent to the aforesaid steps, the customer replies whether to accept the budget file. When the customer replies accepting the budget file, the customer feeds back a preparation order (PO), wherein this preparation order is a formal order written according to the budget file. The order check module 200 transmits the preparation order to the order receiver module 250. However, if the customer replies not accepting the budget file, the order check module 200 feeds back the reply of the customer to the transmitting unit 155 of the budget module 150 (as shown in FIG. 2), so as to modify the budget file and create a new budget file.

Reference is made to FIG. 3. FIG. 3 is a function block diagram of the order receiver module 250 shown in FIG. 1. The order receiver module 250 includes a verification unit 260, a modification unit 270, and a mail transmitter unit 280. The verification unit 260 is used for verifying whether the preparation order provided by the customer complies with the budget file. The modification unit 270 is used for modifying the preparation order, and the mail transmitter unit 280 is used for feeding back the preparation order modified by the modification unit 270 to the customer, so that the customer can check again. Particularly, the order receiver module 250 receives the preparation order, wherein the related content and conditions of the preparation order are only open to the business department, economic management department, and finance department. The verification unit 260 first grabs the budget file created by the budget module 150 (as shown in FIG. 1), and verifies whether the content of the preparation order complies with the budget file, wherein the verification items includes the product model, price, delivery, payment clause, due date, quantity and the like, so as to ensure the understanding to the budget file at the customer end is constant to that at the production end. If the content of the preparation order complies with the budget file, the verification unit 260 transmits the preparation order to the delivery module 300 (as shown in FIG. 1), to prepare for production and delivery. If the content of the preparation order does not comply with the budget file, the verification unit 260 transmits the preparation order to the modification unit 270. The modification unit 270 modifies the preparation order according to the content of the budget file, and the modified preparation order is fed back to the customer end by the mail transmitter unit 280 to be checked by the customer again. In one or more embodiments, the mail transmitter unit 280 may be arranged in the cloud system. The modification unit 270 can uploads the modified preparation order to the cloud system, and the customer can also grab the modified preparation order from the cloud system, but the invention is not limited to this

Reference is made to FIG. 4, FIG. 4 is a function block diagram of the delivery module 300 shown in FIG. 1. In one or more embodiments, the delivery module 300 includes a check unit 310, a packaging unit 320, and a storage and delivery unit 330. The check unit 310 is used for checking the inventory or production plan of the touch and display device. The packaging unit 320 is used for arranging product checking and packaging operations to the touch and display device. The storage and delivery unit 330 is used for arranging a shipping operation to the packaged touch and display device.

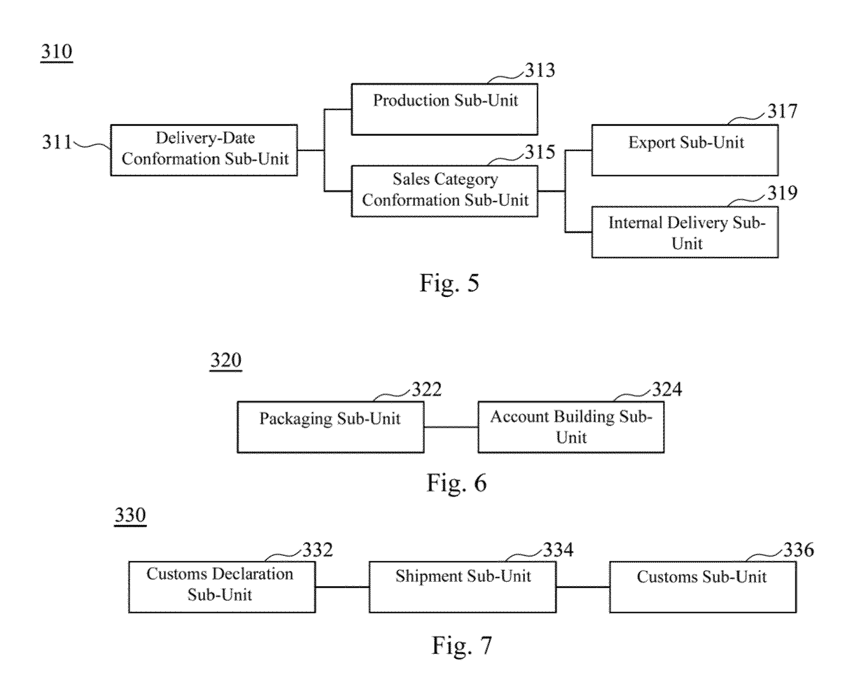

Hereafter, the check unit 310 is described in details. Reference is made to FIG. 5. FIG. 5 is a function block diagram of the check unit 310 shown in FIG. 4. The check unit 310 includes a due-date checking sub-unit 311, a production sub-unit 313, a sales-type checking sub-unit 315, an export sub-unit 317 and an internal delivery sub-unit 319. Particularly, after the delivery module 300 (as shown in FIG. 1) receives the preparation order, the due-date checking sub-unit 311 of the check unit 310 checks whether the current inventory is enough before delivery according to the due date stated in the preparation order. If the current inventory is not enough, a sales order (SO) is created according to the predicted due date, illustrating the delivery quantity and date, wherein the product requirement of the customer is a total sum of the inventory quantity and the production output. If the current inventory is not enough, the production sub-unit 313 arranges producing new products. Additionally, the sales-type checking sub-unit 315 determines whether to provide a delivery number (DN) according to the type (export or internal delivery) of the new requirement, wherein each SO corresponds to a DN, which is the basis for delivering and managing a shipping order, an invoice, and a customs declaration. If it is for export, the export sub-unit 317 provides the DN. Particularly, after the export sub-unit 317 checks the prices stated in the preparation order and a credit line of the customer, a shipping notice (SN) is signed, and the inventory or production plan is checked to establish the DN. If it is delivered internally, the internal delivery sub-unit 319 establishes the SN, and then signs the SN after the inventory or production plan is checked.

Reference is made to FIG. 6. FIG. 6 is a function block diagram of the packaging unit 320 shown in FIG. 4. After the production sub-unit 313 of the check unit 310 (as shown in FIG. 5) completes new products, the packaging unit 320 performs the product checking and packaging operations. The packaging unit 320 includes a packaging sub-unit 322 and an account creating sub-unit 324. Particularly, the packaging sub-unit 322 is used for arranging product checking and packaging operations to the new products. The packaging sub-unit 322 can be managed by an enterprise management system (such as System Analysis and Program Development Business System; SAP) and Warehouse Management System (WMS). The account creating sub-unit 324 is used for arranging account creating for the new products and waiting for payment from the customer. In this embodiment, if the customer has credit line, the customer can pay after production shipping, but the invention is not limited to this. In other one or more embodiments, the SO may also be created for to production shipping after customer pays.

Reference is made to FIG. 7. FIG. 7 is a function block diagram of the storage and delivery unit 330 shown in FIG. 4. Additionally, the storage and delivery unit 330 includes a customs declaration sub-unit 332, a delivery sub-unit 334, and a Maritime-custom sub-unit 336. The customs declaration sub-unit 332 is used for arranging customs declaration procedures for new product shipping; the delivery sub-unit 334 is used for arranging business processes for new product shipping; and the Maritime-custom sub-unit 336 is used for arranging administrative proceedings for new product shipping. Particularly, the customs declaration sub-unit 332 first arranges import & export and logistics customs through the Tip-Top System and gets files of customs declaration procedures and production shipping ready. Then after the delivery sub-unit 334 arranges and prepares the SN and shipping-related files ready, the Maritime-custom sub-unit 336 can arranging customs clearance operation for the customer and reminding the customer to prepare the payment. The SN and the shipping-related files are all portable document format (PDF) files, and the files all should be stamped with the corporation seal.

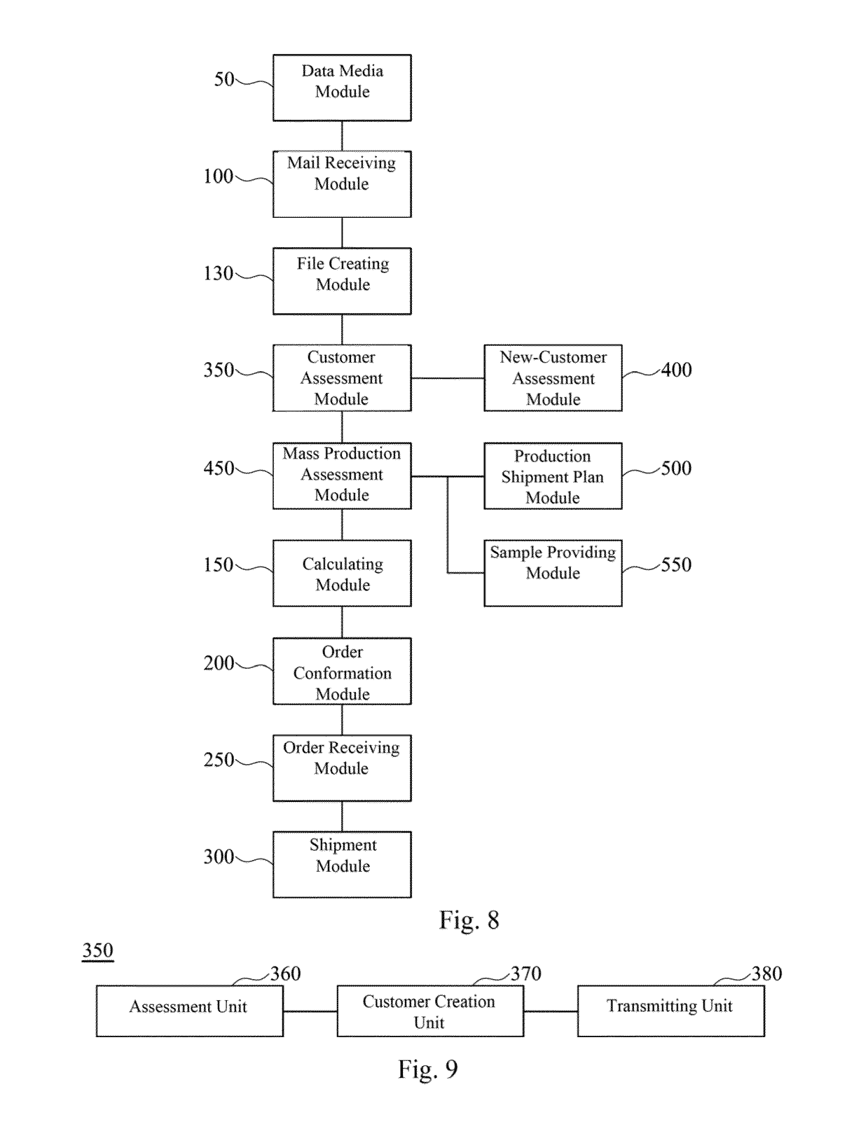

FIG. 8 is a function block diagram of the order management system according to another embodiment of the present invention. In one or more embodiments, the order management system may further include a customer examination module 350 and a new-customer examination module 400, so as to perform further examination to the customer end. The customer examination module 350 is used for checking whether the customer is a new customer. If the customer is the new customer, the new-customer examination module 400 is used for performing new customer application and credit-line examination procedures to the customer.

After the file creating module 130 completes creation of the requirement file, the requirement file can be first optionally delivered to the customer examination module 350 to determine the customer. Reference is made to FIG. 9. FIG. 9 is a function block diagram of the customer examination module 350 shown in FIG. 8. The customer examination module 350 includes an examination unit 360, a customer creation unit 370, and a transmitting unit 380. The examination unit 380 is used for examining the customer, the customer creation unit 370 is used for creating a new-customer data file, and the transmitting unit 380 is used for transmitting the new-customer data file to the new-customer examination module 400 (as shown in FIG. 8). Particularly, if the examination unit 360 determines that the customer is a new customer, the customer creation unit 370 creates a new-customer data file, and meanwhile requests the customer to fill a “customer dynamic management table”. Afterwards the transmitting unit 380 can transmits the new-customer data file and the “customer dynamic management table” to the new-customer examination module 400. If the examination unit 360 determines that the customer is a frequent customer, the examination unit 360 informs the budget module 150 shown in FIG. 8 that the customer is the frequent customer. In one or more embodiments, the customer creation unit 370 may be arranged in a management system (such as Notes system), but the invention is not limited to this

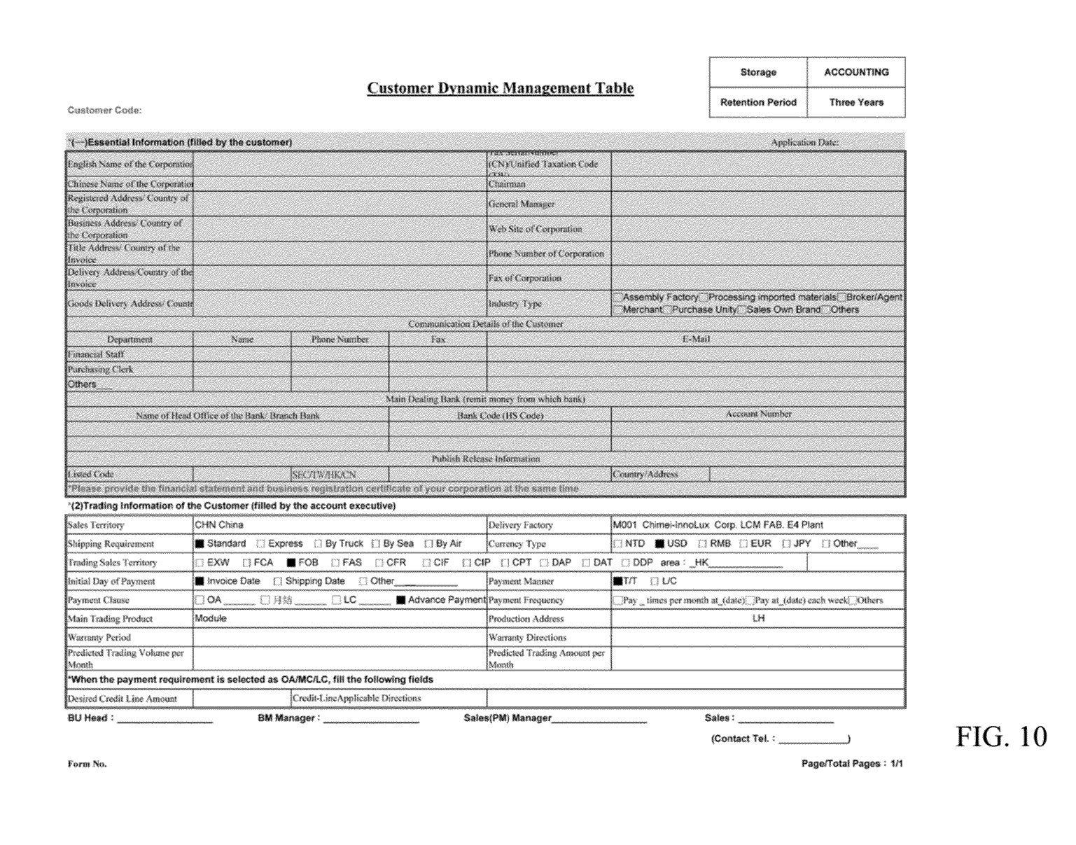

Reference is made to FIG. 10. FIG. 10 is the customer dynamic management table according to an embodiment of the present invention. The “customer dynamic management table” includes two field selections, respectively an essential information bar of the customer and a trading information bar of the customer. The essential information bar of the customer is filled by the customer, and the content thereof includes the essential data, communication details, main dealing bank, and public release information of the corporation at the customer end, so that the new-customer examination module 400 in FIG. 8 can perform subsequent examinations according to these data. The public release information is used for recording subsequent production shipping, payment, and various details of the product content, which are filled one by one in the subsequent periods by the order management system. It should be noted that the aforesaid form of the “customer dynamic management table” is only described for illustration, and is not intended to limit the invention. Those of ordinary skills in the art of the invention can flexibly design the form of the “customer dynamic management table” according to actual requirements.

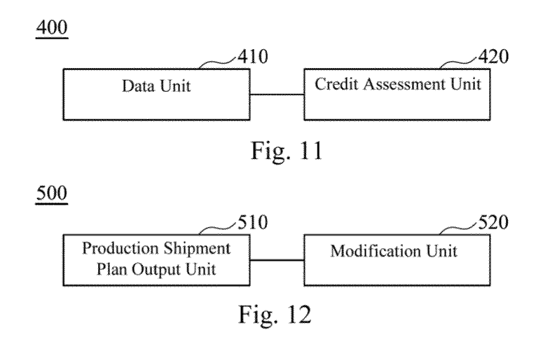

Reference is made to FIG. 11. FIG. 11 is a function block diagram of the new-customer examination module 400 shown in FIG. 8. The new-customer examination module 400 includes a data unit 410 and a credit examination unit 420. The data unit 410 is used for filling the content of the “customer dynamic management table” into the new-customer data file, and the credit examination unit 420 is used for examining the credit line of the customer according to the customer data stored in the “customer dynamic management table”. Thereafter, when the new-customer examination module 400 receives the “customer dynamic management table”, the data unit 410 can fill the new-customer data into the new-customer data file, and then create data related to the new customer and generate a customer code. Afterwards the credit examination unit 420 can apply to predict the credit line according to the quantity, unit price, and payment clause of the new requirement. This predicted credit line is examined by the credit examination unit 420 according to the credit condition, bank limit, operation condition, and cash fluxion condition of the customer to determine whether to open the predicted credit line and output a result file of customer examination. If the examined condition is good, the credit line is open. After the credit line is open, the customer stated in the data unit 410 corresponds to the credit line. However, if the examined condition is not good, the credit line is not open. In one or more embodiments, the data unit 410 may be arranged in the enterprise management system (such as System Analysis and Program Development Business System; SAP), but the invention is not limited to this

Reference is made back to FIG. 8. In one or more embodiments, the order management system may further include a volume-production examination module 450, a production shipping plan module 500, and a sample providing module 550, so to perform a preliminary examination to the production end of the order. The volume-production examination module 450 is used for determining whether the new requirement is a volume-production product. If the new requirement is the volume-production product, the production shipping plan module 500 is used for checking the cost and production shipping plan of the volume-production product. The budget module 150 can reply the due date, the quantity, and the quotation of the touch and display device to the customer according to the cost and production shipping plan of the volume-production product.

Particularly, reference is made to FIG. 12. FIG. 12 is a function block diagram of the production shipping plan module 500 shown in FIG. 8. The production shipping plan module 500 includes a production shipping plan output unit 510 and a modification unit 520. Particularly, when the order management system receives the new requirement, the new requirement can be optionally delivered to the volume-production examination module 450 to determine the new requirement. When the volume-production examination module 450 of FIG. 8 determines that the new requirement is the volume-production product, the product requirement, due date, and price for new requirement are predicted, and provided to the production shipping plan output unit 510 of the production shipping plan module 500. Thereafter the production shipping plan output unit 510 checks the production cost, determines whether the price is reasonable and whether the price is the lowest selling price. The production shipping plan output unit 510 then creates an original-edition production shipping plan with a comprehensive consideration of productivity, materials, and other requirements of the customer, and feeds back the production shipping plan to the budget module 150 (as shown in FIG. 8), and then the budget module 150 replies the due date, the quantity and the price (typically in a form of email or excel file) to the customer, so that the customer checks the content of the original-edition production shipping plan. If the customer does not receive the content of the production shipping plan, the budget module 150 should feed the production shipping plan back to the modification unit 520 of the production shipping plan module 500. The modification unit 520 should modify the content of the production shipping plan to be checked again by the customer. The production shipping plan output unit 510 may be arranged in the production shipping plan (Production, Sales, and Inventory; PSI) system, but the invention is not limited to this.

Additionally, returning to FIG. 8, if the new requirement is not the volume-production product, the sample providing module 550 is used for preparing a sample and providing the due date and cost information thereof to the budget module 150. The budget module 150 then replies the due date, the quantity, and the quotation (typically in a form of email or excel file) to the customer according to the sample and the due date and cost information thereof.

The specific embodiments of the aforesaid data media unit 50, the mail receiver module 100, the file creating module 130, the budget module 150, the order check module 200, the order receiver module 250, the delivery module 300, the customer examination module 350, the new-customer examination module 400, the volume-production examination module 450, the production shipping plan module 500, and the sample providing module 550 may be a software program or a hardware circuit. Those of ordinary skills in the art of the invention can flexibly select the implementation of the aforesaid components according to actual demands, and it is not necessary that these components are all software programs or hardware circuits, but parts of them may be software programs or hardware circuits.

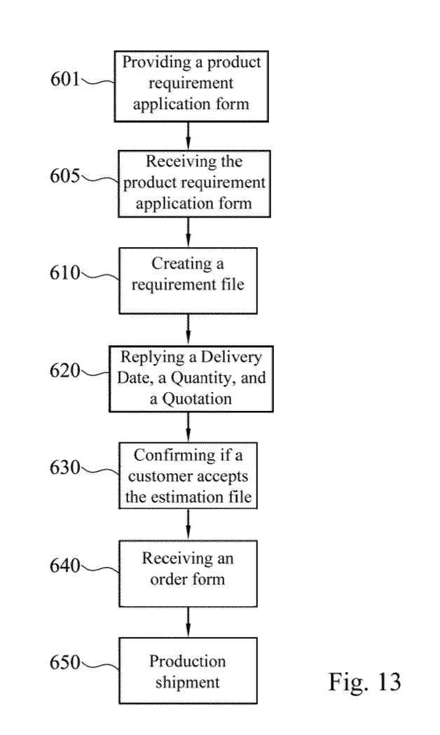

Another aspect of the invention provides an order management method in which the aforesaid order management system is applied. This order management method can be applied for order management of a touch and display device. FIG. 13 is a flow chart of the order management method according to an embodiment of the present invention. First, a manager provides a product requirement application to be downloaded by at least one customer, as shown in step 601. Then the manager receives the product requirement application filled by the customer, as shown in step 605. Thereafter the manager creates a requirement file according to the product requirement application, as shown in step 610. Subsequently the manager predicts a due date, a quantity, and a quotation of the new requirement according to the requirement file, and then replies to the customer, as shown in step 620. Afterwards, the manager checks if the customer accepts the due date, the quantity, and the quotation of the touch and display device, as shown in step 630. If the customer accepts, the manager receives the preparation order from the customer, and checks the preparation order, as shown in step 640. Then the manager arranges production shipping to the customer according to the preparation order, as shown in step 650. As such, the order management method of this embodiment integrates order, budget, delivery, and the like procedures as a whole to manage, which is more integrated than a general management procedure, on one hand being convenient for managing all the procedures unitedly, and on the other hand reducing error probability.

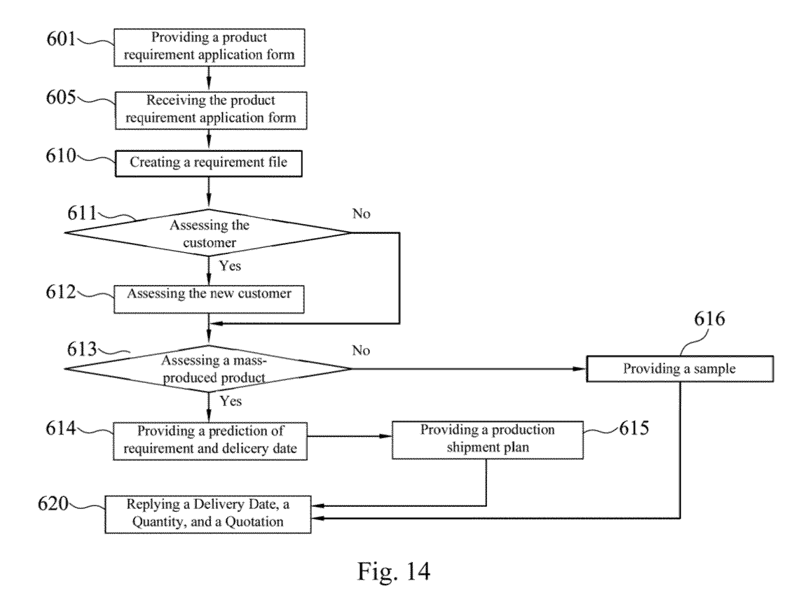

Hereafter, the order management method is described in details. Reference is made to FIG. 14. FIG. 14 is a detailed flow chart of steps 601-620 shown in FIG. 13. First the manager can place a product requirement application in a cloud system, so that a customer with a new requirement can grab the product requirement application from the cloud system and fill the same, as shown in step 601. Thereafter an account executive can also grab the filled application file from the cloud system (step 605) to create the requirement file (step 610). Particularly, the customer can first predict according to the requirement for the touch and display device to be produced, to for example performing a forecast (FCST) to the production requirement of the touch and display device in the following 3-6 months. After the predicted production requirement of the product to be produced is checked, the customer end can download the product requirement application from the cloud system to fill, so as to provide details of the predicted product to be produced to the account executive. This product requirement application is typically has a form of email or excel file. After the application is filled, the customer can feed the product requirement application back to the cloud system, and the account executive then can grab the filled file from the cloud system to create a requirement file, so as to perform the following procedures. It should be noted that, although the transmission medium between the aforesaid account executive and the customer end is the cloud system, the invention is not limited to this. Those of ordinary skills in the art of the invention can flexibly select transmission medium between the account executive and the customer end according to actual demands.

After the new requirement is received, the account executive can optionally examine the customer, i.e., checking whether the customer is a new customer, as shown in step 611. If the customer is the new customer, a new customer application and a credit-line examination procedure is performed to the customer, as shown in step 612. Particularly, after the account executive completes the creation of the requirement file, a determination is first performed to the customer. If the customer is a new customer, the application of the new customer is signed through a management system (such as Notes system), and a new-customer data file is created, and meanwhile the account executive requests the customer to fill the “customer dynamic management table” (referring to FIG. 10). After the customer completes the “customer dynamic management table” and feeds back the same to the account executive, the data of the new customer is filled into the new-customer data file through an enterprise management system (such as System Analysis and Program Development Business System; SAP), and then data related to the new customer is created and a customer code is generated. Then the account executive can apply to predict the credit line according to the quantity, the unit price, and the payment clause of the new requirement. This predicted credit line is examined by the account executive according to the credit condition, bank limit, operation condition, and cash fluxion condition of the customer to determine whether to open the predicted credit line and output a result file of customer examination. If the examined condition is good, the credit line is open. After the credit line is open, the customer stated in the SAP system corresponds to the credit line. However, if the examined condition is not good, the credit line is not open. Additionally, if the customer is not the new customer, this step can be omitted.

Subsequently, the account executive can optionally perform examination to the product under the new requirement, i.e., determining whether the new requirement is a volume-production product, as shown in step 613. If the new requirement is the volume-production product, the manager can first provide a prediction of the requirement and due date, and the SAP system shows “P-BOM”, and the account executive predicts the product requirement, the due date and, the price of the new requirement and provides a volume-production budget file to a production shipping plan (Production, Sales, and Inventory, PSI) system, as shown in step 614. Subsequently the PSI system checks the cost and production shipping plan of the volume-production product, as shown in step 615. On one hand an economic manager acquires requirement and price from the PSI system and checks the cost, then determines whether the price is reasonable and is the lowest selling price, and feeds back the result to the PSI system. On the other hand, a production planner or a salesman can establish an original-edition production shipping plan with a comprehensive consideration of productivity, materials, and other requirements of the customer, and then feeds back the original-edition production shipping plan to the account executive. The account executive then integrates the due date, the quantity, and the quotation of the new requirement according to the cost and production shipping plan of the volume-production product to create a budget file (typically in a form of email or excel file) and reply budget file to the customer, as shown in step 620. The production shipping plan and the budget file can also be uploaded to the aforesaid cloud system by the account executive, and the customer can grab the production shipping plan and the budget file from the cloud system again, but the invention is not limited to this.

Additionally, if the new requirement is not the volume-production product, the SAP system shows “E-BOM”. Under such a condition the material controller cannot prepare materials, and the product manager needs to create a preparation order (PO) by himself/herself to prepare materials, and the product manager prepares a sample and the due date and cost information of the same, as shown in step 616. Subsequently the account executive integrates the due date, the quantity, and the quotation of the new requirement according to the sample and the due date and cost information of the same to generate a budget file, and replies the budget file to the customer, as shown in step 620. Similarly, the budget file may also be uploaded to the aforesaid cloud system by the account executive, and the customer can grab the budget file from the cloud system again, but the invention is not limited to this.

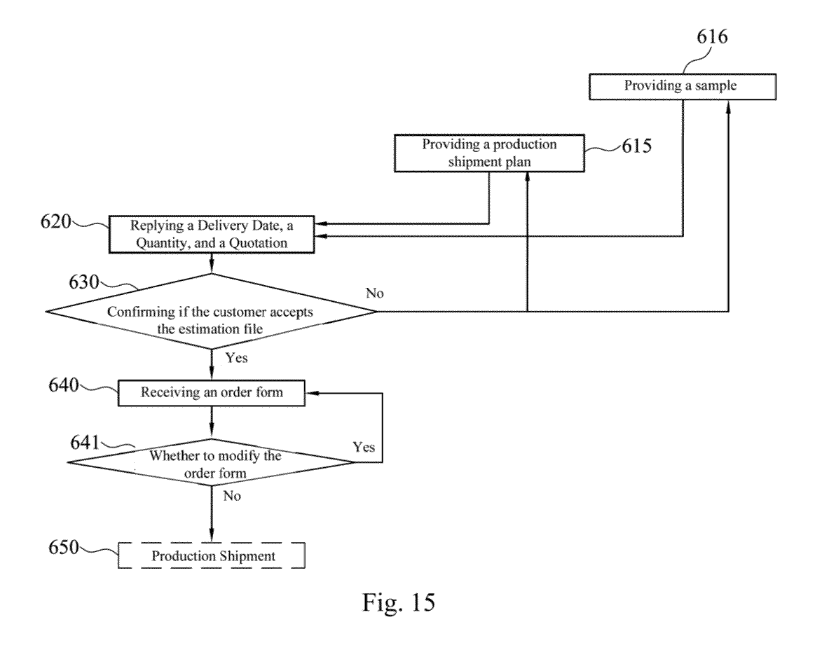

Then reference is made to FIG. 15. FIG. 15 is a detailed flow chart of steps 620-641 shown in FIG. 13. After the budget file is fed back to the customer, the account executive checks if the customer receives the budget file, as shown in step 630. If the customer does not accept, and the new requirement is the volume-production product, the account executive needs to return back to step 615, to re-provide a new production shipping plan and budget file. If the customer does not accept, and the new requirement is not the volume-production product, the account executive needs to return back to step 616, and re-prepare a new sample and the due date and cost information of the same to the customer. If the customer accepts, the customer end integrates the production shipping plan and/or the budget file to provide a preparation order to the account executive, as shown in step 640. The preparation order typically has a form of PDF file stamped with the corporation seal, and the related content and condition of the preparation order are only open to the business department, economic management department, and finance department. Then the account executive should check whether the product model, price, delivery, payment clause stated in the preparation order are constant with the content previously achieved between two parties, so as to determine whether to modify the preparation order, as shown in step 641. If it is not consistent, the preparation order needs to be modified, and the account executive needs to return to step 640, re-replying the modified preparation order to the customer to check. If it is consistent, the preparation order does not need to be modified, and the account executive can arrange production and production shipping to the customer according to the content of the preparation order, as shown in step 650.

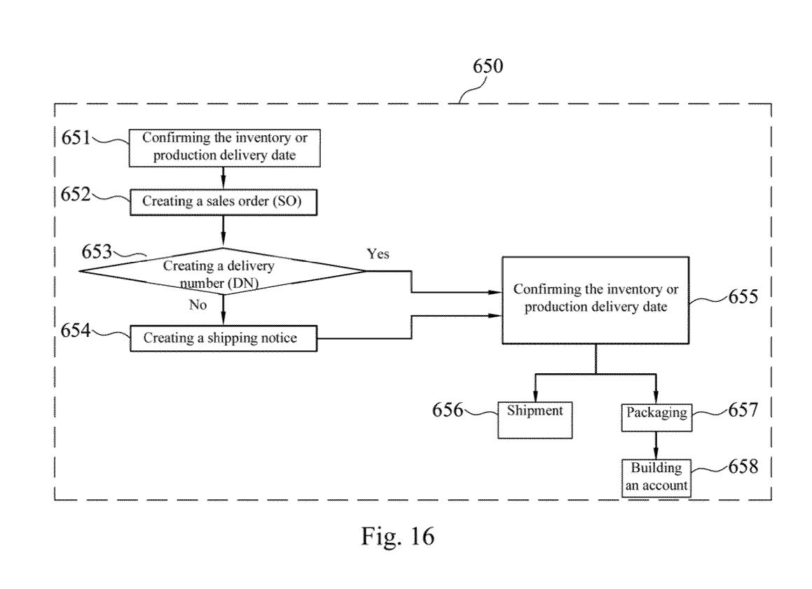

Then reference is made to FIG. 16. FIG. 16 is a detailed flow chart of the step 650 shown in FIG. 13. At this time the account executive needs to check whether the product of the order has an inventory. If the product of the order does not have an inventory, then the production due date is predicted, as shown in step 651. The SAP system checks whether the current inventory is enough before production shipping according the due date replied to the customer. If the current inventory is not enough, the SAP system creates the SO according to the predicted production due date, illustrating the delivery quantity and date, as shown in step 652, wherein the product requirement of the customer is a total sum of the inventory quantity and the production output of the production plan. Subsequently the manager determines whether to provide a delivery number (DN) through the SAP system according to the type (export or internal delivery) of the new requirement, as shown in step 653, wherein each SO corresponds to a DN, which is the basis for delivering and managing a shipping order, an invoice and a customs declaration. If it is delivered internally, the SN can be directly approved without providing the DN, as shown in step 654. Thereafter the SN is delivered to the production manager to check the inventory or production plan, so as to approve the DN, as shown in step 655. Additionally, if it is for export, the SAP system checks the price and the credit line of the customer, and then the SN is signed through the Notes system. Thereafter the SN is delivered to the production manager to check the inventory or production plan, so as to approve the DN, as shown in step 655. Subsequently, the packaging department arranges product checking and packaging operations to the new products, as shown in step 657, wherein the product checking and packaging operations can be managed by the SAP system and the Warehouse Management System (WMS). Thereafter the manager can create the account, as shown in step 658. Then, the customs affairs department can arrange shipping operation to the packaged touch and display device, as shown in step 656. Particularly, the customs affairs department can first arrange import & export and logistics customs through the Tip-Top System and gets files of customs declaration procedures and production shipping ready, and then after the account executive arranges and prepares the SN and shipping-related files ready, a customs clearance operation can be arranged for the customer and the customer is reminded to prepare the payment. The SN and the shipping-related files are all portable document format (PDF) files, and the files all should be stamped with the corporation seal. The aforesaid payment operation is applicable to a customer with the credit line. That is, the customer can pay after production shipping, but the invention is not limited to this. In other one or more embodiments, the SO may also be created for production shipping after customer pays.

Although the invention has been disclosed with reference to the above embodiments, these embodiments are not intended to limit the invention. It will be apparent to those of skills in the art that various modifications and variations can be made without departing from the spirit and scope of the invention. Therefore, the scope of the invention shall be defined by the appended claims.

1. A computer implemented order management method applied with respect to a touch display device, comprising:
providing a product requirement application form to be downloaded by at least one customer;
receiving the product requirement application form filled out by the customer;
creating a requirement file according to the product requirement application form;
estimating a delivery date, a quantity, and a quotation of the touch display device according to the requirement file and then providing this information to the customer;
confirming if the customer accepts the delivery date, the quantity, and the quotation of the touch display device;
receiving an order form from the customer if the customer accepts, and confirming a content of the order form; and
arranging shipment to the customer according to the order form.

2. The computer implemented order management method of claim 1, further comprising:
determining whether a new product requirement is a mass-produced product;
confirming a cost and a production shipment plan of the mass-produced product, if the new product requirement is the mass-produced product; and
wherein the act of providing the delivery date, the quantity, and the quotation of the touch display device to the customer comprises: according to the cost and the production shipment plan of the mass-produced product, providing the delivery date, the quantity, and the quotation of the touch display device to the customer.

3. The computer implemented order management method of claim 1, further comprising:
determining whether a new product requirement is a mass-produced product;
arranging to prepare a sample and providing the delivery date and cost information of the sample to the customer, if the new product requirement is not a mass-produced product; and
wherein the act of providing the delivery date, the quantity, and the quotation of the touch display device to the customer comprises: according to the sample and the delivery date and cost information of the sample, providing the delivery date, the quantity, and the quotation of the touch display device to the customer.

4. The computer implemented order management method of claim 1, further comprising:
confirming whether the customer is a new customer; and
performing a new-customer application procedure and an assessment procedure of a credit line to the customer, if the customer is a new customer.

5. The computer implemented order management method of claim 1, wherein the act of arranging shipment to the customer comprises:
confirming an inventory or a production plan of the touch display device;
arranging a product selection and packaging operation performed with respect to the touch display device; and
arranging a shipping operation with respect to the packaged touch display device.

6. An computer implemented order management system applied with respect to a touch display device, comprising:
a data media module for providing a product requirement application form to be downloaded by at least one customer;
a mail receiving module for receiving the product requirement application form filled out by the customer;
a file creating module for creating a requirement file according to the product requirement application form;
a calculating module for estimating a delivery date, a quantity, and a quotation of the touch display device according to the requirement file and then providing this information to the customer;
an order confirmation module for confirming whether the customer accepts the delivery date, the quantity, and the quotation of the touch display device;
an order receiving module for receiving a order form provided by the customer if the customer accepts, and confirming the content of the order form; and
a shipment module for arranging shipment to the customer according to the order form.

7. The computer implemented order management system of claim 6, further comprising:
a mass production assessment module for determining whether a new product requirement is a mass-produced product; and
a production shipment plan module for confirming a cost and a production shipment plan of the mass-produced product if the new product requirement is the mass-produced product;
wherein the calculating module provides a delivery date, a quantity, and a quotation of the touch display device to the customer according to the cost and the production shipment plan of the mass-produced product.

8. The computer implemented order management system of claim 6, further comprising:
a mass production assessment module for determining whether the new product requirement is a mass-produced product; and
a sample providing module for preparing a sample and providing the delivery date and cost information of the sample to the customer if the new product requirement is not a mass-produced product;
wherein the calculating module provides the delivery date, the quantity, and the quotation of the touch display device to the customer according to the sample and the delivery date and cost information of the sample.

9. The computer implemented order management system of claim 6, further comprising:
a customer assessment module for confirming whether the customer is a new customer; and
a new-customer assessment module for performing a new-customer application procedure and an assessment procedure of a credit line to the customer if the customer is a new customer.

10. The computer implemented order management system of claim 6, wherein the shipment module comprises:
a confirmation unit for confirming the inventory or production plan of the touch display device;
a packaging unit for arranging a product selection and packaging operations with respect to the touch display device; and
a storage and delivery unit for arranging a shipping operation with respect to the packaged touch display device.
